(19) United States
(12) Patent Application Publication
(10) Pub. No.: US 2008/0217798 A1
(43) Pub. Date: Sep. 11, 2008

(54) MOLD STRUCTURE AND THE MANUFACTURING METHOD THEREOF

(75) Inventors: Chao-Chun Huang, Changhua (TW); Fuh-Yu Chang, Hsinchu (TW); Cheng-Hsuan Lin, Taoyuan (TW); Tune-Hune Kao, Hsinchu (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsinchu (TW)

(21) Appl. No.: 11/737,742

(22) Filed: Apr. 19, 2007

(30) Foreign Application Priority Data
Mar. 9, 2007 (TW) 096108115

(51) Int. Cl. B29D 7/01

(52) U.S. Cl. 264/1.34; 249/177

(57) ABSTRACT

A mold structure and the manufacturing method thereof are disclosed. The mold structure is comprised of: an axle; a roller, axially ensheathing the axle; and a mold having a specific imprint pattern of microstructures formed thereon, being arranged to mount on the periphery of the roller while connecting to the axle; wherein a pulling force is exerted on the mold by the axle for stretching the mold while enabling the same to tensely adhere upon the periphery of the roller.

### FIELD OF THE INVENTION

The present invention relates to a mold structure and the manufacturing method thereof, and more particularly, to a mold having a specific imprint pattern of microstructures formed thereon, being arranged to mount on the periphery of a roller in a manner that a pulling force is exerting on the mold for stretching the mold while enabling the same to tensely adhere upon the roller.

### BACKGROUND OF THE INVENTION

Recently, products of micro electrical mechanical system (MEMS) and micro-structure molding have becoming prevalence, which are being used in industries, such as optical films, applications of high precision measurement, and textile industry, etc. In such industries, a roll-to-roll processing is referred to be the most simple and efficient process capable of mass producing micro structures, as it allows maximally leveraging superb throughput and also delivers manufacturing advantages in the form of continuous processing. The roll-to-roll processing is a technology that is commonly being adapted for producing laser hologram anti-counterfeit marks, flexible displays, optical films and the likes. In any roll-to-roll processing, the manufacturing of its roller is the key to perfection and is achieved by ultra precision machining, by which not only the roller manufacturing is a costly, time-consuming process with low throughput, but also to form a mold with imprint pattern of microstructures that is too complicated or too large can be a difficult task. Not to mention that it will take a long time just to replace a mold during the roll-to-roll processing and the used mold must be discarded and can not be used again.

There are many studies relating to the improvement of roll-to-roll processing. One such improvement is a mold structure for light guide plate, disclosed in TW Pat. No. 95208659. As seen in FIG. 1, the aforesaid mold structure 33 is composed of a mold 331 and a patterning plate 332, in which a plurality of micro structures are formed on the patterning plate 332 while the patterning plate is configured and mounted on the mold 331 by a fixing means, such as a vacuuming device, a magnetic member, or an adhesive, whichever is capable of enabling the patterning plate 332 to be removed and replace in a rapid manner. However, the aforesaid mold structure can only be used in the press-molding process as shown in FIG. 1 and can not be used as the mold structure for a roll-to-roll processing since the rolling of the mold structure for a long period of time might cause the mold of imprint patterns, i.e. the patterning plate 332 to loose and fall off the roller.

### SUMMARY OF THE INVENTION

In view of the disadvantages of prior art, the primary object of the present invention is to provide a mold structure and the manufacturing method thereof, by which a mold having a specific imprint pattern of microstructures formed thereon can be arranged to mount on the periphery of a roller in a manner that a pulling force is exerting on the mold for stretching the mold while enabling the same to tensely adhere upon the roller. In view of throughput, it can facilitate the mass production of large-sized mold. In view of processing time, the configuration of the mold upon the roller makes it ease to replace the mold so that change time of a roll-to-roll processing is reduced. In view of cost, it is considerably cheaper since the lifespan of the mold of the invention is comparatively longer.

To achieve the above object, the present invention provides a mold structure, comprising: an axle; a roller, axially ensheathing the axle; and a mold having a specific imprint pattern formed thereon, being arranged to mount on the periphery of the roller while connecting to the axle; wherein a pulling force is exerted on the mold by the axle for stretching the mold while enabling the same to tensely adhere upon the periphery of the roller.

Preferably, the roller is rolling in relative to the rolling of the axle while both is rolling centering the axis of the axle.

Preferably, the axle can be activated to roll within the sheathing of the roller while the roller is immobile without rolling.

Preferably, the mold can be a cylinder fabricated by wrapping an elongated flat strip for meeting the two ends of the strip together while enabling the specific imprint pattern thereof to be disposed at the outer surface of the cylinder.

Preferably, the meeting of the two ends of the cylinder-like mold forms a connection part extending axially by a specific length inside the cylinder-like mold.

Preferably, the roller is configured with a via trough, extending along the axial direction of the roller while penetrating through the same radially so that the connection part of the cylinder-like mold can pass therethrough and thus connect to the axle ensheathed by the roller.

Preferably, the via trough cuts open an axial side of the roller.

Preferably, the axle further comprises: a shaft; a positioning groove, formed on the shaft; and a pinch plate, arranged to be mounted on the positioning groove; wherein, at least a positioning pin is configured in the positioning groove to be used for piercing through a corresponding positioning hole formed on the connection part of the mold.

Preferably, the pinch plate is further comprised of at least a positioning hole, each being used for enabling the corresponding positioning pin configured upon the positioning groove of the axle to pass therethrough.

Preferably, the pinch plate is connected to the positioning groove by the use of a connection member.

Preferably, the connection member can be detached for separating the pinch plate from the positioning groove.

Preferably, the connection member is structured as the formation of at least a screw hole formed inside the positioning groove, each at a position corresponding to at least a screw hole formed on the pinch plate, thereby, the pinch plate can be screw-fixed to the positioning groove by the use of at least a screw bolt.

Preferably, the axial length of the cylinder-like mold is not larger than that of the roller.

Preferably, the mold has a specific imprint pattern of microstructures formed thereon.

Preferably, each microstructure of the specific imprint pattern is formed by a LIGA-like process and is a figure selected from the group consisting of a one-dimensional microstructure and a two-dimensional microstructure.

Preferably, the characteristic size of each microstructure of the specific imprint pattern is smaller than 100 μm.

Preferably, the mold is made of a material selected from the group consisting of nickel, iron, copper, and other metals as well as their alloys.

Preferably, the roller can be made of a metal, such as steel, iron, etc., or can be made of a non-iron material.

Preferably, a fixing means, selected from the group consisting of a magnetic member and an adhesive, is disposed at a position between the outer surface of the roller and the mold.

To achieve the above object, the present invention provides a method for manufacturing a mold structure, which comprises the steps of:
(a) providing a roller and a mold having a specific imprint pattern of microstructures formed thereon; and
(b) exerting a pulling force on the mold for stretching the mold while enabling the same to tensely adhere upon the periphery of the roller.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic view of a mold structure for light guide plate, disclosed in TW Pat. No. 95208659.

FIG. 2 is an exploded view of a mold and its axle according to the present invention.

FIG. 3 is a three-dimensional diagram showing an assembly of a mold and an axle being configured with a roller according to the present invention.

FIG. 4 shows a mold structure of the invention, before exerting a pulling force upon the mold.

FIG. 5A is a schematic diagram depicting the exerting of a pulling force upon a mold by an axle according to the present invention.

FIG. 5B shows the result of the exerting of a pulling force of FIG. 5A.

FIG. 6 shows a mold structure of the invention, after the exerting of the pulling force.

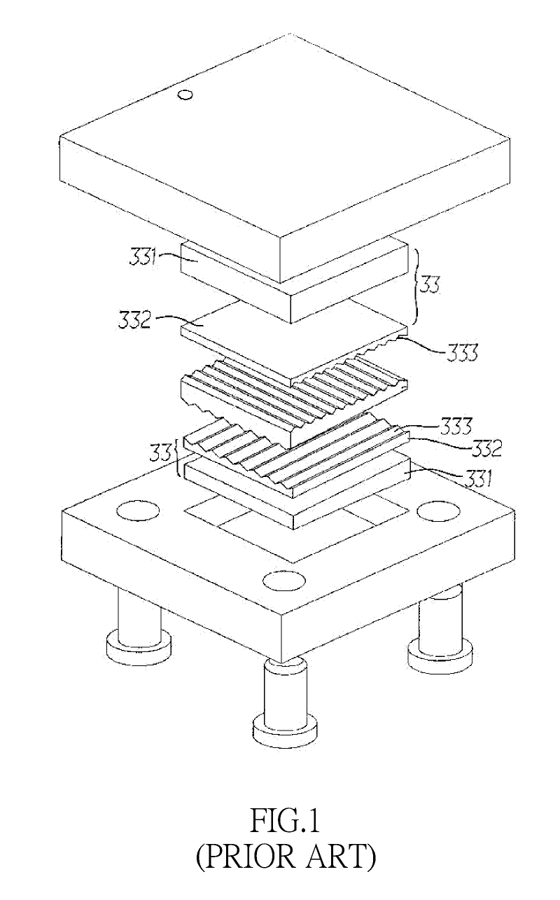

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

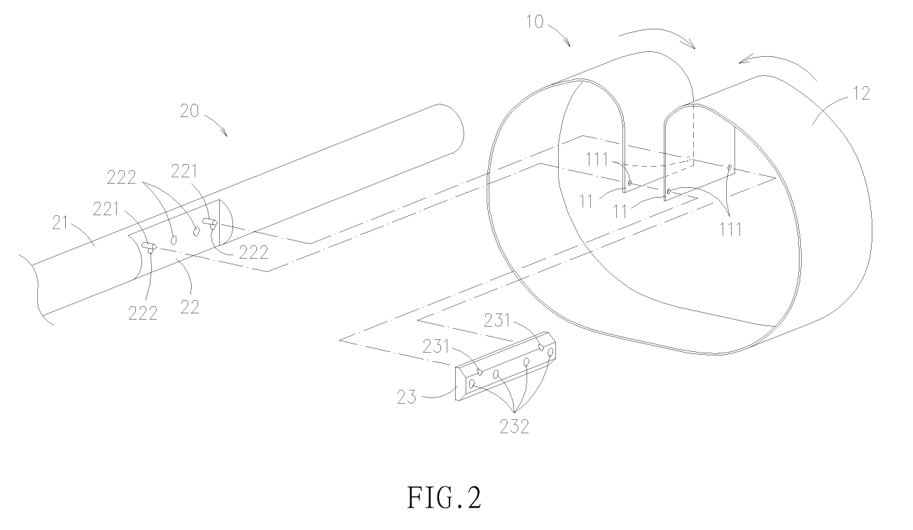

Please refer to FIG. 2, which is an exploded view of a mold and its axle according to the present invention. The mold 10 of FIG. 2 is a cylinder fabricated by wrapping an elongated flat strip for meeting the two ends of the strip together while enabling the specific imprint pattern thereof to be disposed at the outer surface 12 of the cylinder, in which the meeting of the two ends of the cylinder-like mold 10 forms a connection part 11 extending axially by a specific length inside the cylinder-like mold. Moreover, the mold 10 is made of a material selected from the group consisting of nickel, iron, copper, and other metals as well as their alloys, and each microstructure of the specific imprint pattern is formed by a LIGA-like process and is a figure selected from the group consisting of a one-dimensional microstructure and a two-dimensional microstructure, whereas the characteristic size of each microstructure of the specific imprint pattern is smaller than 100 μm. As those relating to such LIGA-like process as well as those mold structures fabricated by the same, adapted for LCD optical film production, heat transfer printing or UV rubber heating transfer printing, are all known to those skilled in the art and thus are not described further herein.

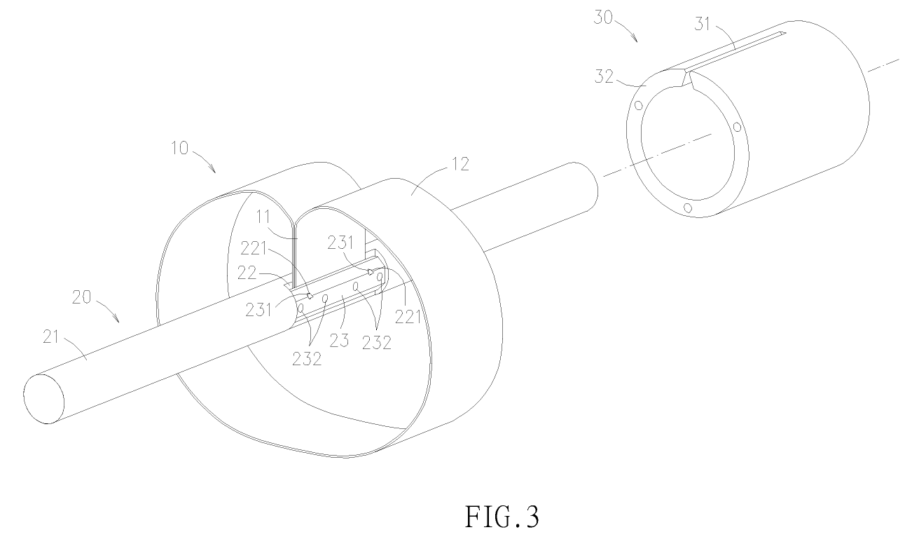

As seen in FIG. 2 and FIG. 3, the mold 10 is paired with an axle 20, which is composed of a shaft 21, a positioning groove 22 and a pinch plate 23. The positioning groove 22 is formed on the shaft 21 at a position about the center of the shaft 21 while the pinch plate 23 is capable of being connected to the positioning groove 22. As the connection part 11 of the mold 10 is further comprised of at least a positioning hole 111 and the pinch plate 23 is also comprised of at least another positioning hole 231 corresponding thereto, at least a positioning pin 221 is configured in the positioning groove 21 to be used for piercing through first a corresponding positioning hole 231 and then the positioning hole 111 of the connection part 11 whereas the shaft 21 is axially received inside the cylinder-like mold 10, by which the connection part 11 and the pinch plate 23 can be held fixedly at the positioning groove 22. In order to force the pinch plate 23 to press exactly on the connection part 11 of the mold 10, a connection member is used for connecting the pinch plate 23 to the positioning groove 22 that is detachable so as to enable the pinch plate 23 to separate from the mold 10 easily when there is required to replace or change the mold 10. In FIG. 2, the connection member is structured as the formation of at least a screw hole 222 formed inside the positioning groove 22, each at a position corresponding to at least a screw hole 232 formed on the pinch plate 23, thereby, the pinch plate 23 can be screw-fixed to the positioning groove 22 by the use of at least a screw bolt. On the contrary, by screwing loose the bolt and thus removing the same out of the screw holes 222, 232, the pinch plate 23 can be separated from the positioning groove 22 easily. However, another connection member composed of hitches is also suitable that is not limited by the aforesaid structure of screw holes and bolts.

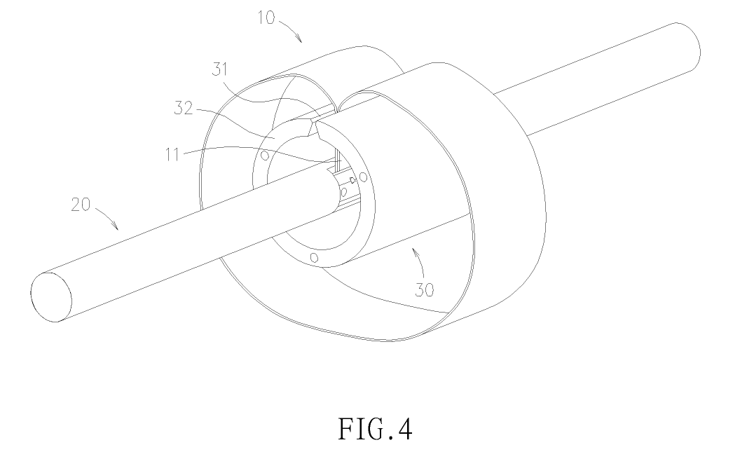

As seen in FIG. 3 and FIG. 4, in addition to the assembly of the mold 10 and the axle 20, the mold structure further comprises a roller 30, which can be made of a metal, such as steel, iron, etc., or can be made of a non-iron material. As seen in FIG. 3, the roller 30 is configured with a via trough 31, which is extending along the axial direction of the roller 30 while penetrating through the same radially and cutting open an axial side 32 of the roller 30 so that the connection part 11 of the cylinder-like mold 10 can pass therethrough and thus connect to the axle 20 ensheathed by the roller 30 so as to forms a mold structure as shown in FIG. 4. In FIG. 4, the axle 20 is ensheathed by the roller 30 while enabling the cylinder-like mold 10 to surround the roller 30.

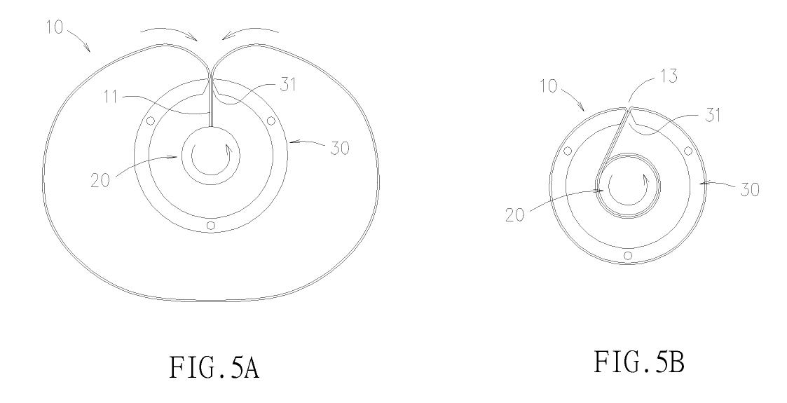

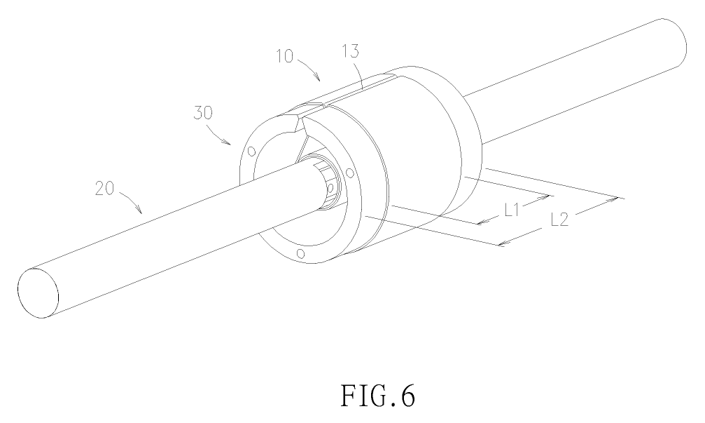

Please refer to FIG. 5A, which is a schematic diagram depicting the exerting of a pulling force upon a mold by an axle according to the present invention. As seen in FIG. 5, the mold 10 is just loosely surrounding the outer periphery of the roller 30 that is not tightly wrapped thereon. Thus, a pulling force is required to be exerted on the mold 10 by the axle 20 for stretching the mold 10 while enabling the same to tensely adhere upon the outer periphery of the roller 30. In FIG. 5A, the pulling force is generated by actuating the axle 20 to rotate about its axial center while maintaining the roller 30 without rolling. By the rotation of the axle 20 as seen in FIG. 5B, a portion of the mold 10 can be pulled to pass through the via trough 31 and wrap upon the axle 20, thereby, the mold 10 is stretched and thus tensely adhere upon the outer periphery of the roller 30 after several rotations of the axle 20 or the axle 20 is rotated by a specific angle. As soon as the mold 10 is tensely adhere upon the outer periphery of the roller 30, the rotation of the axle 20 is stopped and a mold structure is achieved. In FIG. 6, a fixing means, such as a magnetic member or an adhesive, etc., is disposed at a position between the outer surface of the roller 30 and the mold 10 for enhancing adhesion between the two. It is noted that the relative movement of the axle 20 and the roller 30 is not limited by the aforesaid manner, i.e. the axle 20 is activated to rotate while maintaining the roller 30 without rolling, that both of the axle 20 and the roller 30 can be activate to rotate simultaneously, but only at different directions, or the roller 30 is activated to rotate while maintaining the axle 20 without rolling. The principle is that the axle 20 should be activated to rotate in relative to the rolling of the roller 30. Moreover, the pulling force exerting upon the mold 10 by the axle 20 should be controlled with respect to the thickness, the material of the mold as well as the external dimension of the roller 30. As the mold is commonly made of a metal, it is usually strong enough to sustain certain pulling force without damaging the microstructures formed thereon. Ideally, by matching the width of the via trough 31 and the thickness of the mold 10, the tightly adhered mold 10 should be about to fill and seal the via trough 31. However, in actual practice, it is more than common that a gap 13 will be form at the joint of the mold 10 and the via trough 31. Thus, a metal filler is required to fill and level up the gap 13 so as to main the smoothness and integrity of the mold 10. In addition, the axial length L1 of the cylinder-like mold 10 is preferred to be no larger than that L2 of the roller 30, and the printable area of the mold 10 is designed with respect to the external diameter of the roller 30 which matches the axial length L1 of the cylinder-like mold 10.

In conclusion, a method for manufacturing a mold structure can be provided, which comprises the steps of:
(a) providing a roller and a mold having a specific imprint pattern of microstructures formed thereon; and
(b) exerting a pulling force on the mold for stretching the mold while enabling the same to tensely adhere upon the periphery of the roller.

The aforesaid manufacturing method not only is simple and rapid to implement, but also it can facilitate the mass production of large-sized mold in view of throughput, and it is easy to assemble a mold upon a roller for facilitating the replacement of the mold so that change time of a roll-to-roll processing is reduced in view of processing time, and it is considerably cheaper since the lifespan of the mold of the invention is comparatively longer in view of cost so as to be applied for mass producing films of nano-scaled microstructure. No matter the mold structure of the invention is being implemented in heat transfer printing or UV rubber heating transfer printing, the manufacturing time as well as the manufacturing cost of the mold structure can be reduced effectively so that it is suitable to be adapted by industries, such as electric optical industry, optical industry and consumer product industry, for producing products, such as backlight plate, anti-reflective film, and so on.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A mold structure, comprising:
an axle;
a roller, axially ensheathing the axle; and
a mold having a specific imprint pattern formed thereon, being arranged to mount on the periphery of the roller while connecting to the axle;
wherein a pulling force is exerted on the mold by the axle for stretching the mold while enabling the same to tensely adhere upon the periphery of the roller.

2. The mold structure of claim 1, wherein the roller is rolling in relative to the rolling of the axle while both is rolling centering the axis of the axle.

3. The mold structure of claim 1, wherein the mold can be a cylinder fabricated by wrapping an elongated flat strip for meeting the two ends of the strip together while enabling the specific imprint pattern thereof to be disposed at the outer surface of the cylinder.

4. The mold structure of claim 3, wherein the meeting of the two ends of the cylinder-like mold forms a connection part extending axially by a specific length inside the cylinder-like mold.

5. The mold structure of claim 4, wherein the roller is further comprised of a via trough, extending along the axial direction of the roller while penetrating through the same radially so that the connection part of the cylinder-like mold can pass therethrough and thus connect to the axle ensheathed by the roller.

6. The mold structure of claim 4, wherein the axle further comprises:
a shaft;
a positioning groove, formed on the shaft; and
a pinch plate, arranged to be mounted on the positioning groove

7. The mold structure of claim 6, wherein, as the connection part of the mold is further comprised of at least a positioning hole, at least a positioning pin is configured in the positioning groove to be used for piercing through a corresponding positioning hole formed on the connection part of the mold.

8. The mold structure of claim 7, wherein the pinch plate is further comprised of at least a positioning hole, each being used for enabling the corresponding positioning pin configured upon the positioning groove of the axle to piece therethrough.

9. The mold structure of claim 6, wherein the pinch plate is connected to the positioning groove by the use of a connection member, and the connection member is structured as the formation of at least a screw hole formed inside the positioning groove, each at a position corresponding to at least a screw hole formed on the pinch plate, thereby, the pinch plate can be screw-fixed to the positioning groove by the use of at least a screw bolt.

10. The mold structure of claim 3, wherein the axial length of the cylinder-like mold is not larger than that of the roller.

11. The mold structure of claim 1, wherein the mold has a specific imprint pattern of microstructures formed thereon, and each microstructure of the specific imprint pattern is formed by a LIGA-like process and is a figure selected from the group consisting of a one-dimensional microstructure and a two-dimensional microstructure.

12. A method for manufacturing a mold structure, comprising the steps of:
(a) providing a roller and a mold having a specific imprint pattern of microstructures formed thereon; and
(b) exerting a pulling force on the mold for stretching the mold while enabling the same to tensely adhere upon the periphery of the roller.

13. The manufacturing method of claim 12, wherein the mold is substantially an elongated flat strip.

14. The manufacturing method of claim 13, wherein the exerting the pulling force of step (b) further comprises the steps of:
(b1) wrapping the elongated flat strip for meeting the two ends of the strip together and forming a cylinder-like mold while enabling the specific imprint pattern thereof to be disposed at the outer surface of the cylinder; and
(b2) receiving the roller inside the cylinder-like mold.

15. The manufacturing method of claim 14, wherein the meeting of the two ends of the cylinder-like mold in step (b1) is used to form a connection part extending axially by a specific length inside the cylinder-like mold.

16. The manufacturing method of claim 15, wherein the connection part is capable of being fixed attached to an axle, the axle comprising:
a shaft, being received inside the cylinder-like mold;
a positioning groove, formed on the shaft; and
a pinch plate, arranged to be mounted on the positioning groove.

17. The manufacturing method of claim 16, wherein as the shaft is capable of being received inside the roller and the roller is further comprised of a via trough which is extending along the axial direction of the roller while penetrating through the same radially, the connection part of the cylinder-like mold can pass the via trough and thus connect to the shaft received inside the roller.

18. The manufacturing method of claim 17, wherein as the roller is capable of rolling in relative to the rolling of the shaft of the axle while both is rolling centering the axis of the shaft, a pulling force is exerted on the mold by the shaft for pulling a portion of the mold to pass through the via trough and thus stretching the mold while enabling the same to tensely adhere upon the outer periphery of the roller.

19. The manufacturing method of claim 18, wherein the gap formed at the position of the via trough where the mold is stretching and adhering upon the roller is filled and leveled up by the use of a metal filler.

20. The manufacturing method of claim 16, wherein as the connection part of the mold is further comprised of at least a positioning hole, at least a positioning pin is configured in the positioning groove to be used for piercing through a corresponding positioning hole formed on the connection part of the mold for holding the connection part fixedly at the positioning groove.

21. The manufacturing method of claim 20, wherein the pinch plate is further comprised of at least a positioning hole, each being used for enabling the corresponding positioning pin configured upon the positioning groove to piece therethrough after it had pieced through the positioning hole of the connection part, thereby, the pinch plate can press upon the connection part for further helping to hold the connection part fixedly at the positioning groove.
